(19) United States
(12) Patent Application Publication
(10) Pub. No.: US 2025/0252124 A1
(43) Pub. Date: Aug. 7, 2025

(54) SYSTEM AND METHOD FOR INTEGRATING ARTIFICIAL INTELLIGENCE ASSISTANTS WITH WEBSITE BUILDING SYSTEMS

(71) Applicant: Wix.com Ltd., Tel Aviv (IL)

(72) Inventors: Yuval AVIYAM, Rishon Lezion (IL); Oron DAR, Ramat Gan (IL); Ron KEREN, Ramat Gan (IL); Yaniv BEN SIMON, Ramat Gan (IL)

(21) Appl. No.: 18/931,252

(22) Filed: Oct. 30, 2024

Related U.S. Application Data
(60) Provisional application No. 63/550,805, filed on Feb. 7, 2024.

(51) Int. Cl. G06F 16/332; G06F 16/33

(52) U.S. Cl. CPC G06F 16/3329; G06F 16/3347

(57) ABSTRACT

A system for evaluating responses generated by a language learning model (LLM) for a query from an end-user of a website of a website building system (WBS) includes an input processor, a content engine, a prompt generator, and a chat triad. The input processor receives the query. The content engine retrieves relevant content from a content management system (CMS) of the WBS. The prompt generator prompts the LLM to generate an answer according to the query and content. The chat triad evaluates relevance and accuracy of the generated answer by assigning relevance values to relationships between the query, content, and answer; determining a combined score; evaluating the score against criteria; and determining whether to present the answer to the end-user.

### CROSS REFERENCE TO RELATED APPLICATIONS

This application claims priority from U.S. provisional patent application 63/550,805, filed Feb. 7, 2024, and which is incorporated herein by reference.

### FIELD OF THE INVENTION

The present invention relates generally to website interaction systems and to artificial intelligence-assisted website interaction in particular.

### BACKGROUND OF THE INVENTION

Website building systems (WBS) have become increasingly popular for creating and managing online presences for businesses and individuals. These systems typically provide visual editing tools and templates to allow users to design and customize websites without requiring extensive coding knowledge.

A WBS typically handles the creation and editing of visually designed applications (such as a website) consisting of pages, containers and components. Pages may be separately displayed and contain components. Components may include containers as well as atomic components. Reference is made to FIG. 1, which is a schematic block-diagram illustration of a website building system (WBS) 2 which may be used for building a website 3, in accordance with some demonstrative embodiments of the present invention. WBS 2 may be used to build, produce, edit, and/or generate website 3, which may comprise pages 4 which may include components 5 (e.g., text, images, videos).

The WBS may also support hierarchical arrangements of components using atomic components (text, image, shape, video etc.) as well as various types of container components which contain other components (e.g., regular containers, single-page containers, multi-page containers, gallery containers etc.). The sub-pages contained inside a container component are referred to as mini-pages, and each of which may contain multiple components. Some container components may display just one of the mini-pages at a time, while others may display multiple mini-pages simultaneously.

The components may be content-less or have internal content. An example of the first category is a star-shape component, which does not have any internal content (though it has color, size, position, attributes, and other parameters). An example of the second category is a text paragraph component, whose internal content includes the internal text as well as font, formatting, and layout information (which is also part of the content rather than being attributes of the component). This content may, of course, vary from one instance of the text paragraph component to another. Components which have content are often referred to as fields (e.g., a “text field”).

Pages may use templates: general page templates or component templates. Specific cases for templates include the use of an application master page containing components replicated in all other regular pages, and the use of an application header or footer (which repeat on all pages). Templates may be used for the complete page or for page sections. The WBS may provide inheritance between templates, pages, or components, including multi-level inheritance, multiple inheritance, and diamond inheritance (i.e., A inherits from B and C and both B and C inherit from D).

The visual arrangement of components inside a page is called a layout. The WBS may also support dynamic layout processing, a process whereby the editing of a given component (or other changes affecting it such as externally-driven content change) may affect other components, as further described in U.S. Pat. No. 10,185,703 entitled “Website Design System Integrating Dynamic Layout and Dynamic Content” granted Jan. 22, 2019, commonly owned by the Applicant and incorporated herein by reference.

A WBS may be extended using add-on applications such as a third party application and its components (TPAs), list applications (such as discussed in US Patent Publication No. US 2014/0282218 entitled “WBS Integrating Data Lists with Dynamic Customization and Adaptation” published Sep. 18, 2014, commonly owned by the Applicant and incorporated herein by reference) and WBS configurable applications (WCAs, such as described in U.S. Pat. No. 11,698,944 entitled “System And Method for Creation and Handling of Configurable Applications for Website Building Systems” granted Jul. 11, 2023, commonly owned by the Applicant and incorporated herein by reference). These third party applications and list applications may be added and integrated into designed websites.

Such third party applications and list applications may be purchased (or otherwise acquired) through a number of distribution mechanisms, such as being pre-included in the WBS design environment, from an Application Store (integrated into the WBS's market store or external to it) or directly from the third party application vendor.

As artificial intelligence (AI) technology has advanced, there has been growing interest in incorporating AI capabilities into website interactions. Chatbots and virtual assistants have emerged as ways to provide automated responses and support to website visitors. These AI-powered tools aim to enhance user engagement and streamline common tasks like answering frequently asked questions or providing product recommendations.

The integration of AI assistants with websites often involves adding a chat interface or widget to the existing site design. This allows visitors to interact with the AI system while still navigating the standard website layout and content.

### SUMMARY OF THE PRESENT INVENTION

There is therefore provided, in accordance with a preferred embodiment of the present invention, a system for evaluating responses generated by a language learning model (LLM) for a query from an end-user of a website of a website building system (WBS). The system includes an input processor, a content engine, a prompt generator, and a chat triad. The input processor is configured to receive the query from the end-user. The content engine is configured to retrieve content from a content management system (CMS) of the WBS relevant to the query. The prompt generator is configured to prompt the LLM to generate an answer according to the query and the content. The chat triad is configured to evaluate relevance and accuracy of the generated answer by assigning a first relevance value to a relationship between the query and the content, assigning a second relevance value to a relationship between the query and the generated answer, assigning a third relevance value to a relationship between the content and the answer, determining a combined score according to at least the first, second, and third relevance values, evaluating the combined score against a predetermined threshold or other criteria, and determining whether to present the generated answer to the end-user according to the evaluating.

Moreover, in accordance with a preferred embodiment of the present invention, the system further includes a query engine configured to convert the query into a structured language format and extract relevant terms from the structured language format to generate a query language for graph-based data models for retrieving the content from the CMS.

Further, in accordance with a preferred embodiment of the present invention, the query engine is further configured to analyze the query to identify key elements including entities, attributes, and conditions, and structure key elements into the structured language format.

Still further, in accordance with a preferred embodiment of the present invention, the content engine is configured to perform a hybrid search using both vector-based and text-based search methodologies to extract relevant information from the CMS.

Additionally, in accordance with a preferred embodiment of the present invention, the hybrid search includes generating vector embeddings to represent website content in a high-dimensional space, and utilizing the vector embeddings to identify conceptually related content.

Moreover, in accordance with a preferred embodiment of the present invention, the system further includes a component integrator configured to integrate relevant website components into the generated answer when the combined score exceeds the predetermined threshold or other criteria.

Further, in accordance with a preferred embodiment of the present invention, the system further includes a visual display handler to select interface components from the website according to context of the query and the generated answer and to adapt the selected interface components to a visual scheme of a chat interface with the end-user.

Still further, in accordance with a preferred embodiment of the present invention, the visual display handler adapts the selected interface components by modifying at least one of: size, internal layout, colors, or fonts of the selected interface components, and extracting action buttons or calls to action from the selected interface components for display in the chat interface.

There is therefore provided, in accordance with a preferred embodiment of the present invention, a method for evaluating responses generated by a language learning model (LLM) for a query from an end-user of a website of the website building system (WBS). The method includes receiving the query from the end-user, retrieving content from a content management system (CMS) of the WBS relevant to the query, prompting the LLM to generate an answer according to the query and the content, and evaluating relevance and accuracy of the generated answer using a chat triad. The chat triad assigns a first relevance value to a relationship between the query and the content, assigns a second relevance value to a relationship between the query and the generated answer, assigns a third relevance value to a relationship between the content and the answer, determines a combined score based on the first, second, and third relevance values, evaluates the combined score against a predetermined threshold or other criteria, and determines whether to present the generated answer to the end-user.

Moreover, in accordance with a preferred embodiment of the present invention, the method further includes converting the query into a structured language format and extracting relevant terms from the structured language format to generate a query language for graph-based data models for retrieving the content from the CMS.

Further, in accordance with a preferred embodiment of the present invention, the converting also analyzes the query to identify key elements including entities, attributes, and conditions, and structure key elements into the structured language format.

Still further, in accordance with a preferred embodiment of the present invention, the retrieving content performs a hybrid search using both vector-based and text-based search methodologies to extract relevant information from the CMS.

Additionally, in accordance with a preferred embodiment of the present invention, the hybrid search includes generating vector embeddings to represent website content in a high-dimensional space, and utilizing the vector embeddings to identify conceptually related content.

Moreover, in accordance with a preferred embodiment of the present invention, the method further includes integrating relevant website components into the generated answer when the combined score exceeds the predetermined threshold or other criteria.

Further, in accordance with a preferred embodiment of the present invention, the method further includes selecting interface components from the website according to context of the query and the generated answer and adapting the selected interface components to a visual scheme of a chat interface with the end-user.

Still further, in accordance with a preferred embodiment of the present invention, the visual selecting interface components adapts the selected interface components by modifying at least one of: size, internal layout, colors, or fonts of the selected interface components, and extracting action buttons or calls to action from the selected interface components for display in the chat interface.

There is therefore provided, in accordance with a preferred embodiment of the present invention, a website building system (WBS). The WBS includes at least one hardware processor, and a chat manager running on the at least one hardware processor in communication with an end-user of a website of the WBS. The chat manager includes an input processor, a query engine, a content engine, an answer engine, and a visual display handler. The input processor is configured to receive and handle incoming chats from the end-user. The query engine is configured to process and refine the incoming chats into a query format. The content engine is configured to extract relevant information from a content management system (CMS) of the WBS using the query format. The answer engine is configured to prompt a language learning model (LLM) using output from the query engine and the content engine and to evaluate relevance and accuracy of responses generated by the LLM. The visual display handler is configured to manage display of chats and the responses to the end-user.

Moreover, in accordance with a preferred embodiment of the present invention, the query engine includes an SQL converter configured to convert the incoming chats into an structured language format, a context analyzer configured to maintain and analyze historical chat context, and a query classifier configured to classify the structured language format into categories.

Further, in accordance with a preferred embodiment of the present invention, the content engine includes a data searcher configured to utilize vector-based and text-based search methodologies to extract relevant information from the CMS, a data validator configured to validate the relevant information, and a data indexer configured to index the relevant information.

Still further, in accordance with a preferred embodiment of the present invention, the answer engine includes a prompt generator configured to create structured prompts for the LLM using the query format and the relevant information, a response synthesizer configured to process output from the LLM, and a chat triad configured to evaluate relevance, accuracy, and coherence of responses generated by the LLM.

There is therefore provided, in accordance with a preferred embodiment of the present invention, a system for processing end-user queries in a website building system (WBS). The system includes at least one hardware processor, and a query engine running on the at least one hardware processor. The query engine includes an SQL converter, a context analyzer, a query classifier, a human language converter, a semantic search generator, and a GQL converter. The SQL converter is configured to convert natural language input from an end-user into a structured query language or tool format. The context analyzer is configured to analyze context of the structured query language format. The query classifier is configured to classify the structured query language into categories. The human language converter is configured to convert the structured query language back into a human-readable format according to the context analyzer and the query classifier. The semantic search generator is configured to generate a semantic search according to the human-readable format. The GQL converter is configured to extract graph query language keywords from the human-readable format according to output from the semantic search generator.

Moreover, in accordance with a preferred embodiment of the present invention, the query classifier is configured to classify the structured query language into categories including no SQL, SELECT, INSERT, UPDATE, and DELETE.

Further, in accordance with a preferred embodiment of the present invention, the query engine further includes an action executor configured to handle execution of INSERT, UPDATE, and DELETE queries classified by the query classifier.

Still further, in accordance with a preferred embodiment of the present invention, the action executor is configured to interface with a content management system of the WBS to perform data modifications requested by the INSERT, UPDATE, and DELETE queries.

There is therefore provided, in accordance with a preferred embodiment of the present invention, a content engine for a website building system (WBS). The content engine includes a data searcher, a data validator, a data indexer, and a data filterer. The data searcher is configured to perform hybrid searches combining vector-based and text-based methodologies on website content in response to a user query and to retrieve content from search results. The data validator is configured to ensure data integrity of the website content. The data indexer is configured to create searchable indexes of the website content from output from the data searcher. The data filterer is configured to refine and prioritize the search results.

Moreover, in accordance with a preferred embodiment of the present invention, the data searcher is further configured to utilize vector embeddings to represent the website content in a high-dimensional space for capturing semantic relationships between different pieces of content.

Further, in accordance with a preferred embodiment of the present invention, the data indexer utilizes a text indexing engine to convert retrieved content and data to a matching document and then index the matching document.

Still further, in accordance with a preferred embodiment of the present invention, the data filterer is further configured to apply a filter to exclude negative terms and to rank results, such that only top ranked results are sent to an answer engine to minimize the size of a prompt sent to a language learning model.

There is therefore provided, in accordance with a preferred embodiment of the present invention, a system for a website building system (WBS). The system includes at least one processor, and an answer engine running on the at least one processor. The answer engine includes a prompt generator, a response synthesizer, a chat triad, and a response formatter. The prompt generator is configured to receive a query and associated content from a content engine and to generate a prompt for a language learning model (LLM) according to the query and the associated content. The response synthesizer is configured to synthesize a response from output of the LLM. The chat triad is configured to evaluate relevance and accuracy of the synthesized response using a chat triad. The response formatter is configured to format the evaluated synthesized response for display on a user interface.

Moreover, in accordance with a preferred embodiment of the present invention, the chat triad evaluates relevance and accuracy by comparing the query, the associated content, and the synthesized response.

Further, in accordance with a preferred embodiment of the present invention, the chat triad assigns relevance scores between the query, the associated content, and the synthesized response.

Still further, in accordance with a preferred embodiment of the present invention, the chat triad determines whether to accept the synthesized response based on relevance scores exceeding predetermined thresholds or other criteria.

There is therefore provided, in accordance with a preferred embodiment of the present invention, a system for integrating artificial intelligence assistants with website building systems. The system includes a website building system (WBS) including a content management system (CMS) storing website information, a chat manager integrated with the WBS, and a visual display handler. The visual display handler is configured to select website components from the CMS based on context of a user interaction, adapt the selected website components to a chat interface by modifying at least one of size, layout, color, or font, and integrate the adapted website components into responses generated by the chat manager for display in the chat interface.

Moreover, in accordance with a preferred embodiment of the present invention, the visual display handler is further configured to extract action buttons from the website components and display the action buttons as interactive elements within the chat interface.

Further, in accordance with a preferred embodiment of the present invention, the visual display handler is further configured to combine extracted action buttons with textual responses generated by the chat manager.

Still further, in accordance with a preferred embodiment of the present invention, the visual display handler is further configured to adapt the website components for display on mobile devices by adjusting size and layout based on screen dimensions of the mobile devices.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic block-diagram illustration of a website building system (WBS) which may be used for building a website, in accordance with some demonstrative embodiments of the present invention;

FIG. 2 is a schematic illustration of an interface to enhance interaction between a WBS and an end-user of a website of the WBS, in accordance with some demonstrative embodiments of the present invention;

FIG. 3 is a schematic illustration of a system for utilizing AI capabilities to enhance interaction between a WBS and an end-user of a website of the WBS in accordance with some demonstrative embodiments of the present invention;

FIGS. 4A and 4B are schematic diagrams showing the continuity of chat within the interface of FIG. 2 and the completion of transactions without having to leave the interface, in accordance with some demonstrative embodiments of the present invention;

FIG. 5A is a schematic illustration of the sub elements of the query engine of FIG. 3, in accordance with some demonstrative embodiments of the present invention;

FIG. 5B is a schematic illustration of the flow of functionality of the query engine of FIG. 5, in accordance with some demonstrative embodiments of the present invention;

FIGS. 6A, 6B and 6C are schematic diagrams showing an example of a generated SQL (standard query language) query from an end-user message and its subsequent conversion to GQL (graph query language), in accordance with some demonstrative embodiments of the present invention;

FIG. 7 is a schematic illustration of the content engine of FIG. 3, in accordance with some demonstrative embodiments of the present invention;

FIG. 8 is a schematic illustration of the answer engine of FIG. 3, in accordance with some demonstrative embodiments of the present invention;

FIG. 9 is a schematic illustration of a chat triad for evaluating the relevance, accuracy, and coherence of responses from a LLM (large language model), in accordance with some demonstrative embodiments of the present invention;

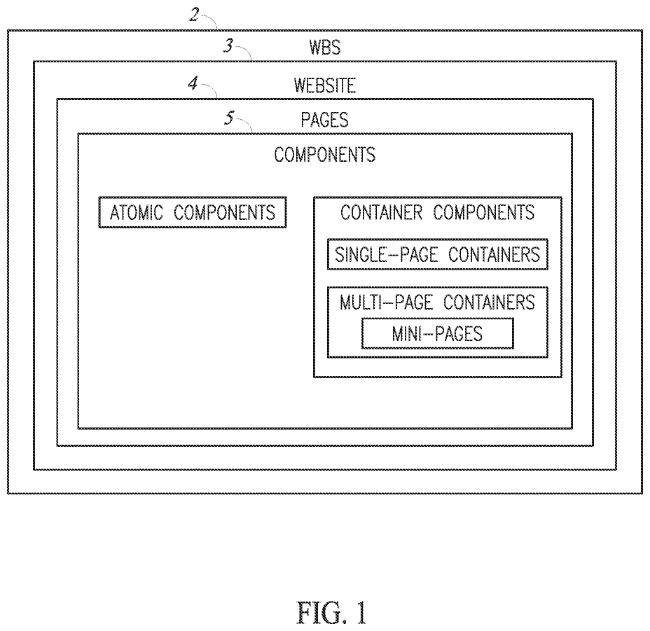

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that the use of artificial intelligence (AI) in website interactions presents opportunities to create more dynamic, personalized user experiences between the website and its visitor or end-user. At the same time, it raises considerations around maintaining brand voice, data privacy, and the appropriate balance between automated and human-driven communications with site visitors. Natural language processing and machine learning techniques may also be used to interpret user queries and generate appropriate responses.

Applicant has also realized that the way we interact with websites on the internet is typically point and click or drag and drop methods and that these methods are quite limiting. The prior art systems for website interaction do not fully leverage the potential of different methods of communication combined with AI to create dynamic, personalized user experiences that seamlessly integrate with website functionality. Existing solutions often treat AI assistants as separate add-ons to websites, rather than deeply integrating them into the core website technology and experience. This approach limits the ability of AI assistants to access and utilize the full range of website components, content, and functionality in generating responses and assisting end users with their queries.

Current AI-powered website interaction systems frequently struggle to maintain coherent dialogues, provide timely and consistently accurate information, and adapt their communication style to match the brand voice and goals of individual websites. Additionally, existing systems often lack robust mechanisms for validating AI-generated responses against website content, potentially leading to inaccurate or irrelevant information being presented to end-users.

Applicant has realized that a more efficient way of website interaction is a system that can use and also maintain control over answer engines, such as those based on GPT-like or Large Language Model (LLM) AI engines for providing answers to queries. The system should be able to provide the LLM engine with the relevant prompts and information by filtering out noise such as stop-words and other non-relevant information (e.g., greetings like “hello” at the beginning of a sentence). The query, question or end-user input may then be converted into any structured query language or tool and then may further be converted into any query language for graph based data models or tools which may enhance vector search and text search capabilities for retrieving precise documents to feed the LLM as a prompt. For the sake of discussion, the description below uses Standard Query Language (SQL) as the structured query language and Graph Query Language (GQL) as the query language for graph based models as part of the system functionality. In other embodiments, Hibernate Query Language (HQL) and XML Query (XQuery) may be used as alternative structured query languages and other query languages for graph based data models or tools may be used instead of GQL.

The system may employ a two-pronged approach: first, it may search for data using conventional SQL queries. Second, it may utilize vector technology for searching. This approach, combined with a phase that translates the SQL query back into natural language, may present a novel method for handling the complexities of natural language interaction with websites in the form of communication channels such as bots, WhatsApp, email etc. The system may provide answers and links related to the content of the pertinent website only and any interaction (i.e., chat) is therefore only based on data associated with the pertinent website. The results are therefore informative and may include links to information on the website.

Furthermore, the system may employ a methodology to check the quality of the returned answers from the answer engine in terms of whether the answer is related to the question, whether the answer is related to the website content and whether the website content is related to the question. Each check may be graded to determine if the answer is correct or not. This may overcome any hallucinogenic responses returned by the answer engine.

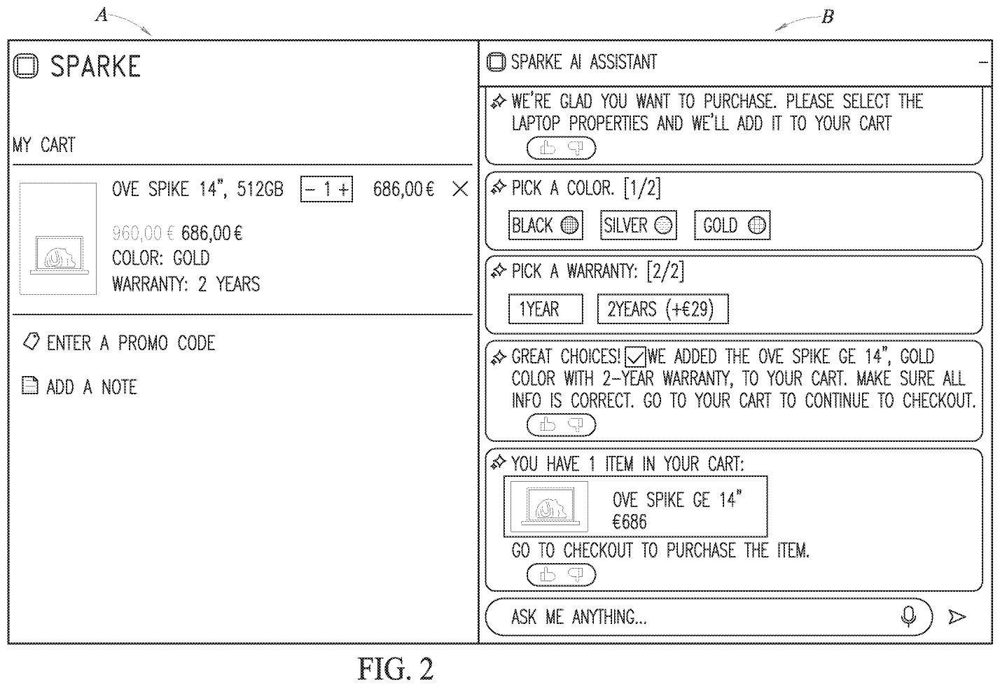

Reference is made to FIG. 2 which shows a screenshot user interface for an e-commerce website called “Sparke” that integrates an AI assistant feature, also known as a chat manager, according to an embodiment of the present invention. The interface may be divided into two main sections: a traditional e-commerce product display A and an AI-powered chat interface B.

On side A, a product called “One Sparke 14”, 512 GB″ is displayed. This section may include standard e-commerce elements such as product information, pricing details, and warranty options. Side B may feature a chat window labeled “Sparke AI Assistant”. This interface may provide a conversational shopping experience, guiding users through the product selection and purchase process.

Chat interface B may include interactive elements that correspond to product options. For example, it may display color selection buttons for “Black”, “Silver”, and “Gold”. Additionally, a dropdown menu for warranty options may be integrated into the chat interface. The chat displayed on chat interface B may demonstrate how an AI assistant or chat manager may guide users through the shopping process. It may offer step-by-step assistance, asking users about their preferences and providing relevant information about the product. As users make selections, the chat manager may confirm their choices and provide a summary of the selected options. This may include details such as the chosen color, storage capacity, and warranty option. Chat interface B may also include a checkout button, allowing users to proceed with their purchase directly.

It will be appreciated that this integrated approach may highlight how AI can be seamlessly incorporated into an e-commerce platform, combining traditional web elements with chats to create a more interactive and personalized shopping experience. The chat manager may adapt its responses based on user input, available product information and context potentially streamlining the purchase process and enhancing end-user engagement.

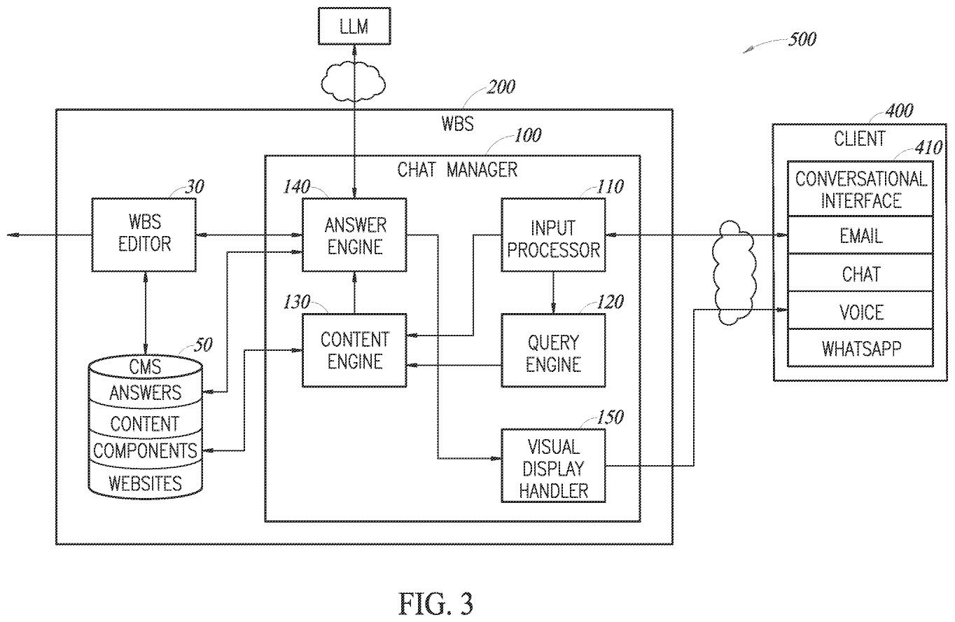

Reference is now made to FIG. 3 which illustrates a system 500 for utilizing AI capabilities to enhance interaction between a WBS and an end-user of a website of the WBS according to an embodiment of the present invention. By embedding AI capabilities within website and website building system architecture, system 500 may enable dynamic, context-aware responses that leverage the full range of website content and functionality.

System 500 may comprise a website building system (WBS) 200 in communication with an answer engine such as a generic language learning model (LLM) 300 and an end user client 400.

WBS 200 may further comprise a chat manager 100, a WBS editor 30 and a WBS content management system (CMS) 50. It will be appreciated that WBS 200 may function as described in U.S. Pat. No. 10,073,923 entitled “SYSTEM AND METHOD FOR THE CREATION AND UPDATE OF HIERARCHICAL WEBSITES BASED ON COLLECTED BUSINESS KNOWLEDGE” granted Sep. 11, 2018, commonly owned by the Applicant, and incorporated herein by reference.

WBS editor 30 may provide a comprehensive set of tools and interfaces for creating, editing, and managing website content within WBS 200. In some embodiments, WBS editor 30 may include visual drag-and-drop functionality, allowing designers using the WBS to easily arrange and customize website elements without requiring extensive coding knowledge.

It will be appreciated that WBS editor 30 may incorporate design capabilities, enabling users to create websites. It may also provide real-time preview functionality, allowing designers to see how their changes will appear on the live website. It will be appreciated that when building a website, a website owner or designer may provide standard answers for responses to visitor queries and may also provide guidance for the use of content and components for his site. For example, a standard instruction may be “never use information from fields X and Y in table Z to provide training data or user answers.” WBS 200 may also allow websites that have embedded third party applications let the third-party applications provide instructions and hints to the use of third-party application components embedded on the website,

WBS editor 30 may include tools for managing various types of content, such as text, images, videos, and interactive elements. In some implementations, WBS editor 30 may offer built-in SEO optimization features, helping users improve their website's visibility in search engine results.

WBS editor 30 may also provide functionality for creating and managing standard responses, which can be used by chat manager 100 when interacting with end-users. This integration may allow website owners to maintain consistent messaging across both traditional website content and AI-assisted interactions.

CMS 50 may store website information, including components, content, and website owner standard responses as described in U.S. Pat. No. 10,073,923.

Chat manager 100 may comprise an input processor 110, a query engine 120, a content engine 130, an answer engine 140, and a visual display handler 150. It will be appreciated that chat manager 100 may function to process incoming chats and manage the content and presentation of appropriate responses. It will also be appreciated that chat manager 100 may have access to all data related to the pertinent website such as products, services, site pages etc. either stored in CMS 50 or via any embedded third party applications where appropriate.

It will be appreciated that a chat or interaction between a website and its end user may include multiple interaction types such as generic, an inquiry or action. A generic interaction does not include data and may therefore be easily handled by chat manager 100. An example is a friendly conversation exchanging pleasantries. An inquiry interaction may include asking for help to find information on the website which could be specific (such as “products under $50”) or broad (such as “offer me a present for my girlfriend's birthday”).

An “action” interaction may include a booking cancellation, tracking on order etc. In some embodiments, the action may be handled directly using underlying site functionality and not via chat manager 100. It will be appreciated that some interactions may affect the behavior of subsequent interactions. For example, when adding an item to a shopping cart, the interaction mode may be reversed, the cart module asks the end-user instead of the end user asking chat manager 100.

Input processor 110 may function to handle all types incoming chats, interactions and actions from all different input methods such as email, chat, voice etc.

Query engine 120, content engine 130, and answer engine 140 may function together to process the incoming chats and actions and to generate appropriate responses. Query engine 120 may process the incoming query and convert it to a format suitable for searching. Content engine 130 may extract relevant information from CMS 50 for the pertinent query. Answer engine 140 may interact with LLM 300 to leverage its natural language understanding and generation capabilities and to check its output.

Visual display handler 150 may function to manage the display of chats and interactions and integrate website components into chat interface 410 as needed. Client 400 may provide a chat interface 410 for interaction between end-users and WBS 200. This interface may facilitate natural language input and display AI-generated responses along with relevant website components.

The functionality of these components is described in more detail herein below.

It will be appreciated that the integration of chat manager 100 within WBS 200 allows website end users to interact with the pertinent website without requiring any configuration by the website designer. Chat manager 100 may automatically generate any required prompts, questions etc. without the designer having to consider any elements and their arrangement on interface 410. It will be appreciated that chat manager 100 may still allow the website designer to provide specific guidelines, hints, standard responses etc. It will be further appreciated that chat manager 100 may also determine at specific points during any chats whether to escalate any interaction so that a site owner or vendor may intervene (full or partially).

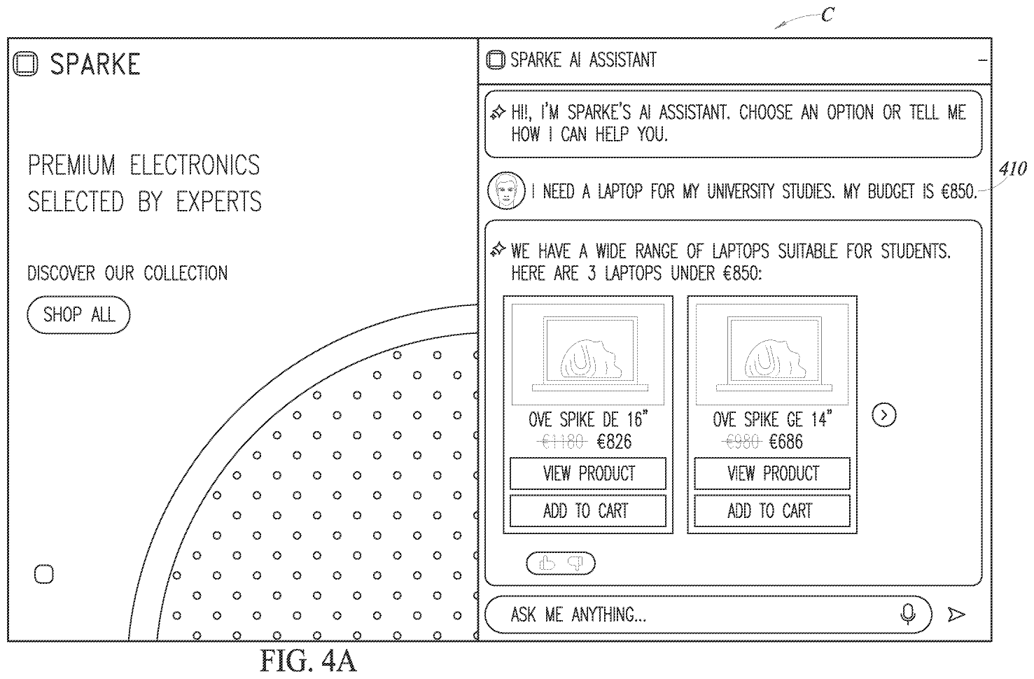

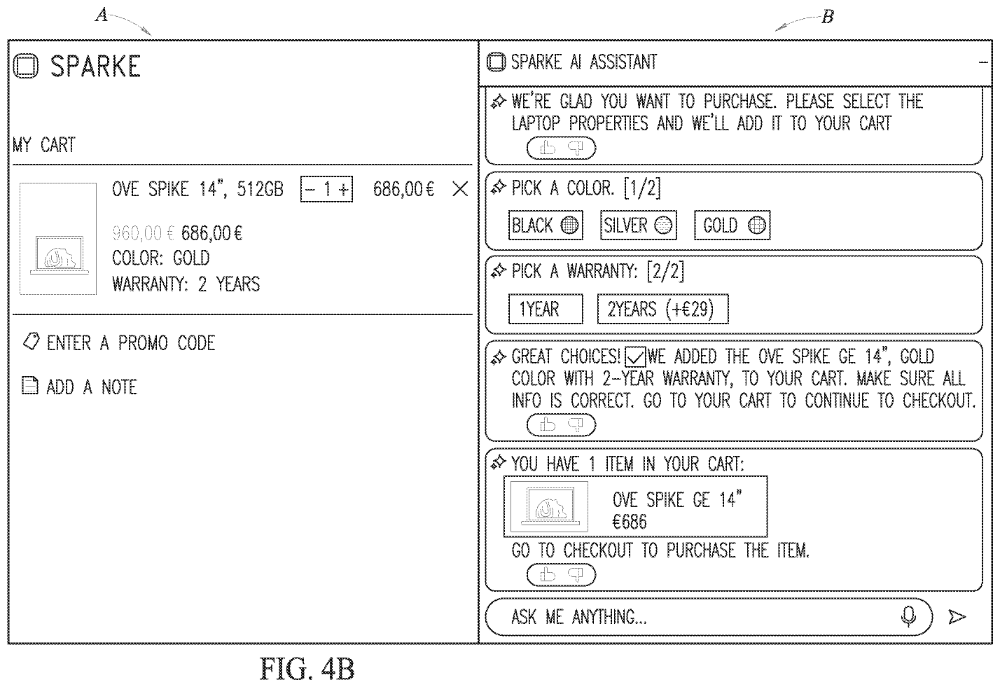

Reference is now made to FIGS. 4A and 4B which illustrate the continuity of chat within interface 410 and the completion of transactions without leaving interface 410. As is shown, interface 410 may provide a conversational shopping experience, guiding end users through product selection and information retrieval processes. The query asked is about laptops under €850, and chat manager 100 has responded by displaying two product options within the chat interface itself. It will be appreciated that the two product options may be the only product options that meet the requirement of being under €850 and are in stock and may also be context correct, i.e., suitable for a university student. Each product option presented in the chat may include an image of the laptop, its name, price, and a “View Product” button. This integration may allow end-users to view and compare products without leaving chat interface 410, streamlining the shopping experience.

It will be appreciated that in this example, the end-user may click on the desired option with his mouse. In other embodiments, interface 410 may support voice chat or additional input forms such as biometric based input devices (such as voice analysis or eye motion detection). In such an embodiment, interface 410 may display an appropriate display logo such as a microphone or speaker. It will be appreciated since different methods of interaction may be supported. Different end-users may choose different operational methods. For example, one end-user may be visually impaired whereas another may be hard of hearing.

It will be further appreciated that interface 410 may be adapted for different sized displays such as mobile devices as described in more detail herein below.

Input processor 110 may listen to and receive incoming chats.

Query engine 120 may function to process and refine the chat input received from end users, removing extraneous or irrelevant words to improve the accuracy and efficiency of subsequent processing steps. Query engine 120 may employ various techniques to identify and filter out “noisy” words that do not contribute to the meaning or intent of the user's query. It will be appreciated that in order to effectively engage in chatting with end users, it is desirable to identify intent for each incoming query or end user message.

Query engine 120 may employ natural language processing techniques to analyze the syntactic structure of the input query, allowing it to distinguish between essential and non-essential elements of the query. This may involve part-of-speech tagging and dependency parsing to identify any key nouns, verbs, and modifiers that convey the end-user's primary intent.

It will be appreciated that in some embodiments, query engine 120 may be context-aware, considering the specific domain or topic of the website to determine which words are most relevant. For e-commerce applications, for example, it may prioritize product-related terms while filtering out general chat elements.

Query engine 120 may also be capable of handling spelling corrections and normalizing variations in word forms, ensuring that minor typographical errors or differences in word usage do not impede the ability of chat manager 100 to understand any end-user intent.

The resulting query from query engine 120 may be in GQL format in order to enhance the vector searches and text searches of content engine 130 as described in more detail herein below. This is to ensure that the resulting prompt to LLM 300 is more accurate since it may cut down on the number of irrelevant documents and content that may be retrieved by content engine 130.

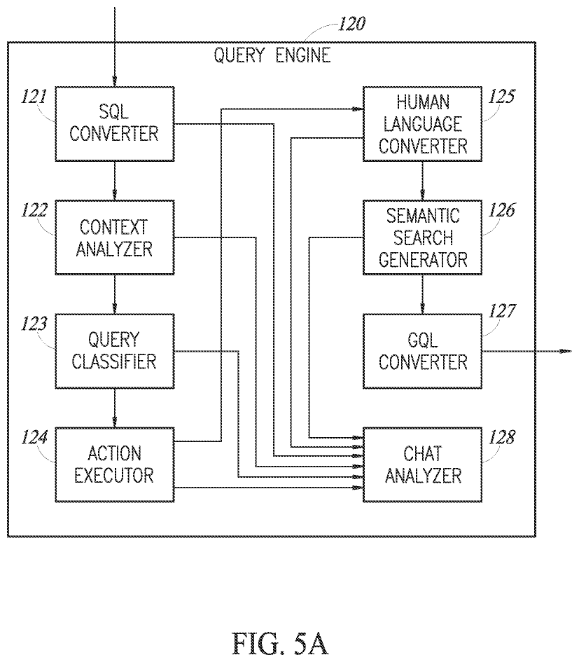

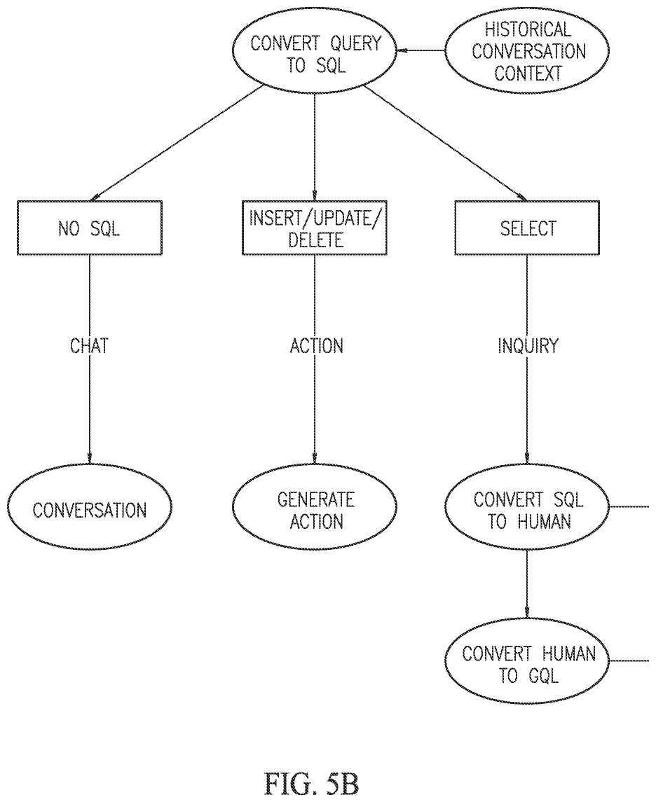

Reference is now made to FIG. 5A, which illustrates the sub elements of query engine 120 and to FIG. 5B which illustrates the flow of functionality of query engine 120.

Query engine 120 may include an SQL converter 121, a context analyzer 122, a query classifier 123, an action executor 124, a human language converter 125, a semantic search generator 126, a GQL converter 127 and a chat analyzer 128.

SQL converter 121 may convert the incoming end user's natural language query into an SQL-like format. It may analyze the input to identify key elements such as entities, attributes, and conditions, then structure these elements into a query format that can be easily processed by other components of chat manager 100.

Context analyzer 122 may maintain and analyze any historical chat context. It may track previous interactions within the same session to provide continuity and improve the relevance of responses. It will be appreciated that previous chats may also be stored in CMS 50 or any alternative session storage repository. Context analyzer 122 may work in conjunction with SQL converter 121 to incorporate contextual information into the generated queries.

Once SQL converter 121 has converted the incoming message into SQL, query classifier 123 may classify the query into several categories, such as:
a. No SQL: Queries that do not require database operations such as generic interactions as described herein above. In this scenario the end-user may just write (for example) “how long have you been in business?” i.e. a response that requires specific business knowledge which is not database-formatted and a response is sent via answer engine 140 using LLM 300 as described in more detail herein below.
b. INSERT/UPDATE/DELETE: Queries that involve data modification. It will be appreciated that for queries classified as INSERT/UPDATE/DELETE, action executor 124 may handle the execution of these actions. action executor 124 may interface with CMS 50 or any other pertinent database to perform the requested modifications.
c. SELECT: Queries that involve data retrieval or inquiry. For SELECT queries human language converter 125 may convert the SQL-like query processed by SQL converter 121 back into natural human language. This conversion may facilitate more natural interactions and improve the ability of chat manager 100 to generate contextually appropriate responses. A SELECT statement may mean that the end-user intent is discovery i.e., a request or change regarding a particular product or catalog item of the website. In this scenario, human language converter 125 may remove the SQL to retrieve human text without any “noise”.

Semantic search generator 126 may use the human language version of the query to perform semantic searches. It may analyze the meaning and intent behind the query to find relevant information that may not be captured by exact keyword matches.

GQL converter 127 may convert the human language query into Graph Query Language (GQL) format. GQL may be used for more complex queries that involve relationships between different entities or concepts within the website's content structure. It will be appreciated that GQL is a way to access databases to narrow down and avoid irrelevant results.

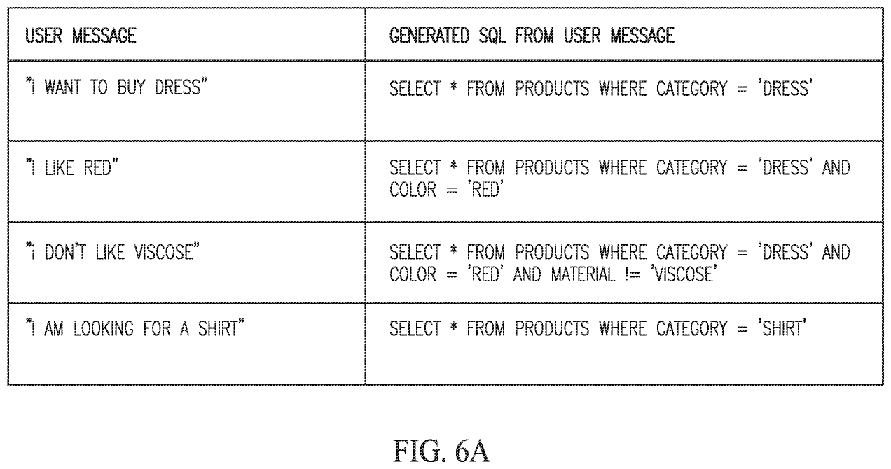

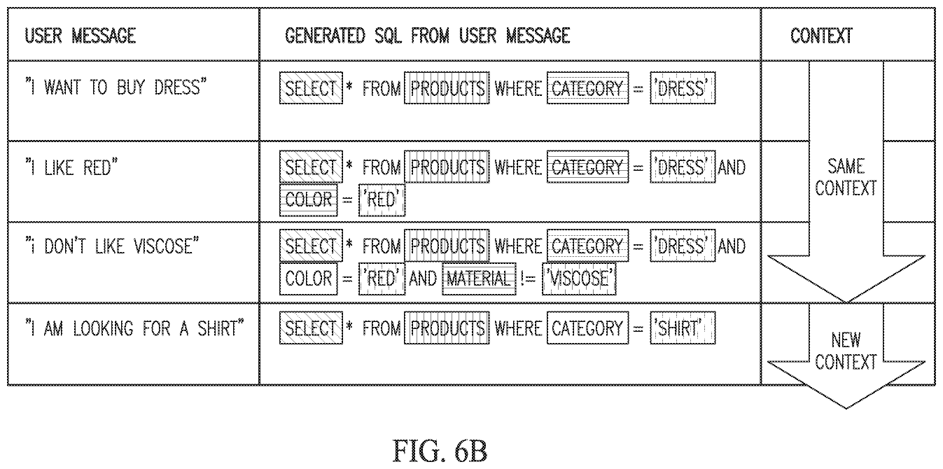

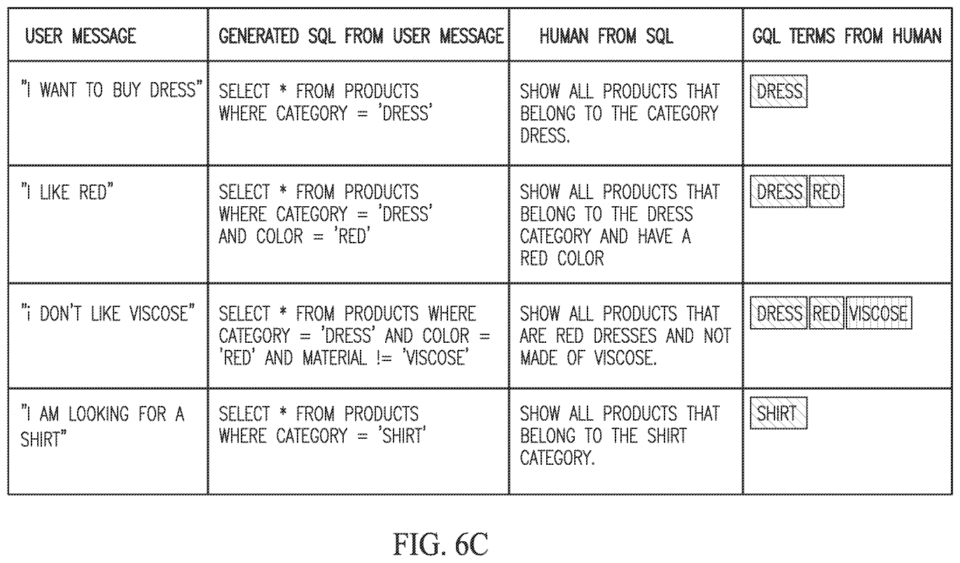

Reference is now made to FIGS. 6A, 6B and 6C which show examples of generated SQL queries from end-user queries or messages. FIG. 6A shows the end-user message and the generated SQL from the message. It will be appreciated that it is important for chat manager 100 to understand whether the context of the backwards and forwards of the dialog between the website and the end-user is changing. FIG. 6B shows how the interaction moves through the ongoing dialog. When the “where” clause starts afresh, it can be interpreted as a new context. FIG. 6C shows the extraction of GQL from the generated SQL which may be used by content engine 130 to query CMS 50 as described in more detail herein below.

Chat analyzer 128 may classify incoming queries and chats to collect insights in order to provide business insights to the website owner. For example, it may classify incoming chats semantically (such as 80% of chats are on Apple Pay).

In some embodiments, chat analyzer 128 may also flag queries directly to the site owner for direct intervention. Such an interaction may be implicit (i.e., the end-user knows he is being routed to the site owner) or may be transparent to the end-user.

A site owner monitoring various interactions may wish to intervene in certain scenarios and answer himself without the process undertaken by chat manager 100. An example may be an enquiry about buying an expensive item, and the site owner may wish to add a personal touch to the chat or make a special offer. In this scenario, chat manager 100 may enable the site owner to manually interact with the user via interface 410.

After the incoming chat is converted into a query and parsed, content engine 130 may retrieve relevant content from CMS 50 (or from the third party application provider for any embedded third party applications) that can be used to generate a prompt or answer by answer engine 140 to LLM 300 as described in more detail herein below. It will be appreciated that the created GQL query by GQL converter 127 may be used for text search and filtering by content engine 130 to retrieve relevant information. Content engine 130 may also continually index website content stored in CMS 50 and ensure data enrichment.

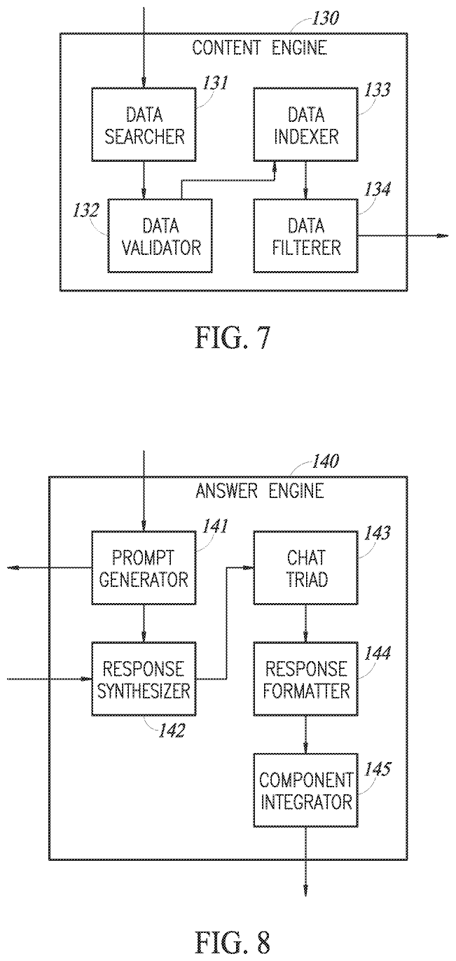

Reference is now made to FIG. 7 which illustrates the sub elements of content engine 130. Content engine 130 may comprise a data searcher 131, a data validator 132, a data indexer 133 and a data filterer 134.

It will be appreciated that content engine 130 may function as a sophisticated retrieval system, leveraging both vector-based and text-based search methodologies to extract relevant information from CMS 50. In one embodiment, data searcher 131 may utilize vector embeddings to represent website content in a high-dimensional space. These embeddings may capture semantic relationships between different pieces of content, allowing for similarity-based searches that go beyond simple keyword matching. The vector-based search may be particularly effective for identifying conceptually related content, even when exact word matches are not present. Vector searches may also leverage machine learning (ML) to capture the meaning and context of unstructured data, including text and images, transforming it into a numeric representation. Frequently used for semantic search, vector search finds similar data using approximate nearest neighbor (ANN) algorithms. It will be appreciated that when compared to a traditional keyword search, a vector search may yield more relevant results and execute faster.

Data searcher 131 may also employ traditional text-based search techniques, which may be useful for precise keyword matching and handling structured data within CMS 50. This embodiment may be particularly effective for queries that require exact matches or specific attribute filtering.

Data searcher 131 may dynamically balance between the two search methodologies based on the nature of the query and the available content. For instance, for product-related queries, it may prioritize structured data searches, while for more open-ended questions, it may lean towards semantic vector searches. Content engine 130 may also be capable of handling multi-modal content, including text, images, and potentially other media types.

Data validator 132 may validate relevant data in CMS 50 for the query created to ensure it is not empty. Data validator 132 may further validate data on the website itself. Data indexer 133 may utilize a text indexing engine (such as Vespa commercially available from Vespa.ai) to convert retrieved content and data to a matching document and then index it. The indexed documents allow for efficient searching and retrieval of content. By incorporating Vespa into its architecture, content engine 130 may be able to handle a wide range of query types and data volumes, from simple keyword searches to complex semantic queries across large-scale datasets. It will be appreciated that the documents may include website pages, media, text, and website components.

Data filterer 134 may apply a filter to exclude negative terms and to rank results. Thus, only top ranked results may be sent to answer engine 140 to minimize the size of the prompt or context sent to LLM 300 as described in more detail herein below. It will be appreciated that ranking may consider factors such as content freshness and user engagement metrics.

The indexed, filtered and ranked documents may then be then utilized by answer engine 140 to create a response to the query by prompting LLM 300 and vetting the returned results as described in more detail herein below.

Reference is now made to FIG. 8 which illustrates the elements of answer engine 140. Answer engine 140 may comprise a prompt generator 141, a response synthesizer 142, a chat triad 143, a response formatter 144, and a component integrator 145.

As discussed herein above, answer engine 140 may function as a response generation system, leveraging the capabilities of LLM 300 and the output of content engine 130 to create contextually appropriate and accurate responses to user queries and chats. Answer engine 140 may generate responses that are not only informative and relevant but also interactive and tailored to the specific context of the website and user query. This approach may help overcome potential limitations of LLM 300 generated responses, such as hallucinations or irrelevant information, by grounding the responses in the website's actual content and functionality. It will be appreciated that a response may include text, product details, articles, events, forms, standard answers, and any other kind of media.

Prompt generator 141 may create structured prompts for LLM 300 using the parsed query and extracted content from content engine 130. These prompts may be designed to elicit responses that are tailored to the specific context of the website and the user chat or query. Prompt generator 141 may incorporate the documents received from content engine 130 which provide relevant website information, product details, and user context to guide LLM 300 towards generating appropriate and accurate responses.

Response synthesizer 142 may process the output from LLM 300, combining it with relevant website components and information to create a cohesive and informative response. This component may ensure that the generated response aligns with the website's content, tone, and branding guidelines.

As discussed hereinabove, chat triad 143 may function as a sophisticated quality control mechanism within answer engine 140 to evaluate and ensure the relevance, accuracy, and coherence of responses generated by LLM 300.

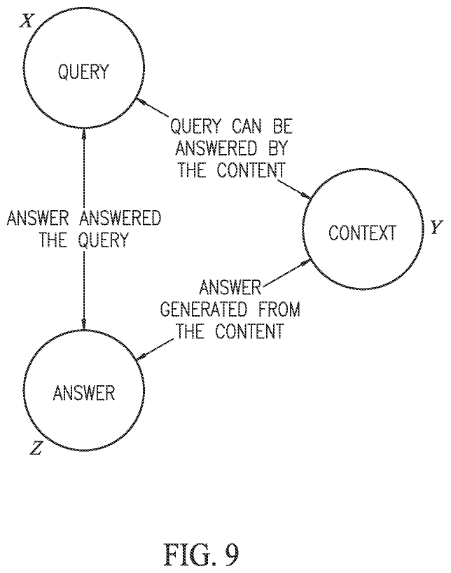

It will be appreciated that a response or answer may be represented as a triangle with 3 vertices representing the original query X, retrieved content Y and answer Z as is illustrated by FIG. 9 to which reference is now made.

The query vertex X of the triangle represents the original query submitted by the user. This may include the natural language input or question that initiates the interaction with chat manager 100.

The content vertex Y represents the retrieved content from CMS 50 (or from third party applications when relevant). This may include relevant website information, product details, or other data extracted by content engine 130 based on the end-user's query.

The answer vertex Z represents the generated answer produced by LLM 300 in response to the prompt created by prompt generator 141.

It will be further appreciated that the edges connecting these vertices illustrate the relationships between these components that chat triad 143 evaluates to ensure the quality and relevance of the generated response. The edge between the query and answer vertices may represent how well the answer addresses the user's original question. The edge between the content and answer vertices may indicate how accurately the answer reflects the website's content. The edge between the query and content vertices may show the relevance of the retrieved content to the user's query.

Chat triad 143 may grade the accuracy of the connections between the three interconnected vertices using LLM 300. It will be appreciated that system 500 may also utilize Retrieval Augmented Generation (RAG) to enhance LLM 300 by training it with facts from external sources. It will be appreciated that in this embodiment, the designer or owner of the website may instruct prompt generator 141 manually using WBS editor 30. For example, LLM 300 may be prompted with language such as “using the context above, grade the coupling and the relevance of question A to this answer B on the scale of 0 to 1. Here are examples of question and answer pairs with a relevance of 1 and here are examples of question and answer pairs with a relevance of 0”.

Each connection may be assigned a relevance value (for example between 0 and 1) indicating the level of significance or relevance between the connected vertices. If the combined score is high (for example 0.9), then it may be assumed that the response is accurate, else if the score is low (such as 0.2), it can be assumed that the response is less accurate.

Chat triad 143 may use pre-determined thresholds such as artificial intelligence determined thresholds and other dynamic thresholds calculated using other mechanisms which may be criteria based to determine whether the response is sufficiently accurate (according to proportion and combination) in order to instruct response formatter 144 and component integrator 145 to finalize the response to be presented.

An example of an irrelevant answer which may create a low score is an online shop that sells clothes which receives a query regarding help planning a trip to New York City. LLM 300 may provide a plan but chat triad 143 will not find any relevance between the answer and the content.

Another example is the case of a visitor asking for the shipping policy for a product in his or her country. If there is missing content in CMS 50 regarding the particular country, LLM 300 may still try to answer the question. The answer may not be deemed accurate because of the missing data from the website (CMS 50) and the relevance score may be low.

It will be appreciated that if the relevance score is low, answer engine 140 may notify the site owner that there is content missing or instruct prompt generator 141 to prompt LLM 300 to provide an updated answer to the user that his request cannot be fulfilled or that an alternative solution is offered to something that might be out of stock.

Response formatter 144 may structure the synthesized response in a format suitable for display in chat interface 410. This may involve organizing the response into paragraphs, bullet points, or other appropriate formats based on the content type and user interface requirements.

Component integrator 145 may incorporate relevant website components, such as product images, buttons, or interactive elements, into the response. This integration may allow for a seamless user experience, enabling users to take actions or access additional information directly within the chat interface.

It will be appreciated that answer engine 140 may work in conjunction with visual display handler 150 to ensure that the responses generated and integrated components are presented effectively via interface 410. As discussed herein above, answer engine 140 may adapt its output based on the device type and screen size, ensuring optimal display across desktop and mobile platforms.

As discussed herein above, visual display handler 150 may handle the display of interface 410, whether it is for the purposes of receiving input for a query or presenting answers and responses. When chat manager 100 is used in parallel to the website, the display (interface 410) may be divided into a “chat area” and a “site area” and may display elements, both passive and active from the site. Visual display handler 150 may select interface components and subcomponents of the website for display according to the output of answer engine 140. Alternatively, visual display handler 150 may generate new ones according to context and chat content. Thus, visual display handler 150 may expand the display in the “chat area” to include elements extracted from the “site area” or to generate components similar or related to these in the “site area” (even if they don't exist in the regular site in the specific component form).

It will be appreciated that when extracting or generating such components, visual display handler 150 may also use hints provided in specific site components, adapted rules (e.g., though rule engine), a specific generative AI model trained and optimized for component selection or generation, previous feedback to such extracted or generated components (by the current or other relevant users) as well as other sources of information.

Visual display handler 150 may also adapt components to different visual schemes (when displayed on interface 410). This may include adapting size, internal layout changes, color changes, font changes, alternative version displays or other changes (including splitting and merging components). Visual display handler 150 may also extract action buttons and other calls to action and display them via visual elements or combine them in the displayed textual interactions.

Visual display handler 150 may further affect the site area display and move between pages and inside pages and may generate auto-generated pages (including for example virtual/list/router based pages)/Visual display handler 150 may also modify displayed pages including their combining and splitting and may auto-fill content with data extracted from or based on the chat.

As discussed herein above, interaction with a user may be vocal i.e., chat manager 100 may handle an incoming voice request. Likewise, chat manager 100 may respond with its answer vocally back to the end-user. In this scenario, visual display handler 150 may make the appropriate conversions.

Thus, system 500 may enable natural language interaction for websites and their end-users or visitors through a chat manager controlled interface which allows for the incorporation of website elements and content without requiring explicit configuration by the website designer. It processes chats into queries, retrieves relevant information from the content management system, and generates contextually appropriate responses which are then checked for quality and accuracy. This approach enhances user engagement and provides personalized experiences while maintaining the website's aesthetic and functional integrity.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type, such as a client/server system, mobile computing devices, smart appliances, cloud computing units or similar electronic computing devices that manipulate and/or transform data within the computing system's registers and/or memories into other data within the computing system's memories, registers or other such information storage, transmission or display devices.

The elements of WBS 200 and in particular the elements of chat manager 100 may be specially constructed for the desired purposes, or may comprise a computing device or system typically having at least one processor and at least one memory, selectively activated or reconfigured by a computer program stored on the computer. The resultant apparatus when instructed by software may turn the general-purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus. The computer readable storage medium may also be implemented in cloud storage.

Some general purpose computers may comprise at least one communication element to enable communication with a data network and/or a mobile communications network.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A system for evaluating responses generated by a language learning model (LLM) for a query from an end-user of a website of a website building system (WBS), comprising:
an input processor configured to receive said query from said end-user;
a content engine configured to retrieve content from a content management system (CMS) of said WBS relevant to said query;
a prompt generator configured to prompt said LLM to generate an answer according to said query and said content; and
a chat triad configured to evaluate relevance and accuracy of said generated answer by:
assigning a first relevance value to a relationship between said query and said content;
assigning a second relevance value to a relationship between said query and said generated answer;
assigning a third relevance value to a relationship between said content and said answer;
determining a combined score according to at least said first, second, and third relevance values;
evaluating said combined score against a predetermined threshold or other criteria; and
determining whether to present the generated answer to said end-user according to said evaluating.

2. The system according to claim 1 further comprising a query engine configured to convert said query into a structured language format and extract relevant terms from said structured language format to generate a query language for graph-based data models for retrieving said content from said CMS.

3. The system according to claim 2 and wherein said query engine is further configured to analyze said query to identify key elements including entities, attributes, and conditions; and structure key elements into said structured language format.

4. The system according to claim 1 wherein said content engine is configured to perform a hybrid search using both vector-based and text-based search methodologies to extract relevant information from said CMS.

5. The system of claim 4 wherein said hybrid search comprises:
generating vector embeddings to represent website content in a high-dimensional space; and
utilizing said vector embeddings to identify conceptually related content.

6. The system of claim 1 and further comprising a component integrator configured to integrate relevant website components into said generated answer when said combined score exceeds said a predetermined threshold or other criteria.

7. The system of claim 6 and further comprising a visual display handler to select interface components from said website according to context of said query and said generated answer and to adapt said selected interface components to a visual scheme of a chat interface with said end-user.

8. The system of claim 7 wherein said visual display handler adapts said selected interface components by modifying at least one of: size, internal layout, colors, or fonts of said selected interface components; and extracting action buttons or calls to action from said selected interface components for display in said chat interface.

9. A method for evaluating responses generated by a language learning model (LLM) for a query from an end-user of a website of said website building system (WBS), the method comprising:
receiving said query from said end-user;
retrieving content from a content management system (CMS) of said WBS relevant to said query;
prompting said LLM to generate an answer according to said query and said content;
evaluating relevance and accuracy of said generated answer using a chat triad, wherein said chat triad:
assigns a first relevance value to a relationship between said query and said content;
assigns a second relevance value to a relationship between said query and said generated answer;
assigns a third relevance value to a relationship between said content and said answer;
determines a combined score based on the first, second, and third relevance values;
evaluates said combined score against a predetermined threshold or other criteria; and
determines whether to present the generated answer to said end-user.

10. The method according to claim 9 further comprising converting said query into a structured language format and extracting relevant terms from said structured language format to generate a query language for graph-based data models for retrieving said content from said CMS.

11. The method according to claim 10 and wherein said converting also analyzes said query to identify key elements including entities, attributes, and conditions; and structure key elements into said structured language format.

12. The method according to claim 9 wherein said retrieving content performs a hybrid search using both vector-based and text-based search methodologies to extract relevant information from said CMS.

13. The method of claim 12 wherein said hybrid search comprises:
generating vector embeddings to represent website content in a high-dimensional space; and
utilizing said vector embeddings to identify conceptually related content.

14. The method of claim 9 and further comprising integrating relevant website components into said generated answer when said combined score exceeds said predetermined threshold or other criteria.

15. The method of claim 14 and further comprising selecting interface components from said website according to context of said query and said generated answer and adapting said selected interface components to a visual scheme of a chat interface with said end-user.

16. The method of claim 15 wherein said visual selecting interface components adapts said selected interface components by modifying at least one of: size, internal layout, colors, or fonts of said selected interface components; and extracting action buttons or calls to action from said selected interface components for display in said chat interface.

17. A website building system (WBS), the WBS comprising:
at least one hardware processor; and
a chat manager running on said at least one hardware processor in communication with an end-user of a website of said WBS, said chat manager comprising:
an input processor configured to receive and handle incoming chats from said end-user;
a query engine configured to process and refine said incoming chats into a query format;
a content engine configured to extract relevant information from a content management system (CMS) of said WBS using said query format;
an answer engine configured to prompt a language learning model (LLM) using output from said query engine and said content engine and to evaluate relevance and accuracy of responses generated by said LLM; and
a visual display handler configured to manage display of chats and said responses to said end-user.

18. The website building system of claim 17, wherein said query engine comprises:
an SQL converter configured to convert said incoming chats into an structured language format;
a context analyzer configured to maintain and analyze historical chat context; and
a query classifier configured to classify said structured language format into categories.

19. The website building system of claim 18, wherein said content engine comprises:
a data searcher configured to utilize vector-based and text-based search methodologies to extract relevant information from said CMS;
a data validator configured to validate said relevant information; and
a data indexer configured to index said relevant information.

20. The website building system of claim 19 wherein said answer engine comprises:
a prompt generator configured to create structured prompts for said LLM using said query format and said relevant information;
a response synthesizer configured to process output from said LLM; and
a chat triad configured to evaluate relevance, accuracy, and coherence of responses generated by said LLM.
